(19) United States
(12) Patent Application Publication
(10) Pub. No.: US 2025/0061420 A1
(43) Pub. Date: Feb. 20, 2025

(54) TRACKING VEHICLE ASSEMBLY USING PART LINKING

(71) Applicant: Toyota Motor Engineering & Manufacturing North America, Inc., Plano, TX (US)

(72) Inventors: Ammar Saeed, Mississauga (CA); Zidi Zhou, Kitchener (CA)

(73) Assignees: Toyota Motor Engineering & Manufacturing North America, Inc., Plano, TX (US); Toyota Jidosha Kabushiki Kaisha, Toyota-shi (JP)

(21) Appl. No.: 18/452,021

(22) Filed: Aug. 18, 2023

(51) Int. Cl. G06Q 10/0875; G06F 16/22

(52) U.S. Cl. CPC G06Q 10/0875; G06F 16/2255

(57) ABSTRACT

Systems, methods, and other embodiments described herein relate to creating a part database to aid in assembling parts into a vehicle. In one embodiment, a method includes acquiring a bill of materials (BOM) identifying at least parts included within a vehicle build. The method includes generating a unique identifier for the BOM by determining identifiers of the parts and a quantity of each of the parts within the BOM; merging the identifier and the quantity of each of the parts into an array; and hashing the array into the unique identifier. The method includes storing the unique identifier as a primary key for the BOM within a database that includes BOMs of vehicles and assemblies.

### TECHNICAL FIELD

The subject matter described herein relates, in general, to tracking vehicle assembly from assorted parts and, more particularly, to providing a unique linkage between parts and bills of materials (BOMs) that allows for optimized vehicle assembly tracking.

### BACKGROUND

As vehicles have become more sophisticated with greater numbers and types of capabilities, the volume of parts has increased. Such greater number of parts being incorporated into modern vehicles can come from more than one supplier and have different lead times before being available for assembly at a vehicle manufacturing plant. While supply chain and distribution networks can lower the volatility and/or lead times associated with receiving ordered vehicle parts, disruptions, backorders, and recalls can degrade a manufacturing plant's ability to efficiently maintain a work rate that results in vehicles ready for sale and/or delivery.

The threat of part availability volatility is compounded by manufacturing plants being tasked with the capability of assembling vehicle with different bill of material (BOM) lists. As such, plant capabilities to change between different BOMs, or respond to a change to an existing BOM, have conventionally been computed using slow and inefficient databases. For instance, single parts are often characterized by type and groups of parts, which makes evaluation of a plant's availability to change to assemble a vehicle with a different BOM tedious and inaccurate.

### SUMMARY

In one embodiment, example systems relate to organizing vehicle assembly information to provide an efficient source for evaluating vehicle manufacturing capabilities. In an example, a method includes acquiring a bill of materials (BOM) identifying at least parts included within a vehicle build. The method includes generating a unique identifier for the BOM by determining identifiers of the parts and a quantity of each of the parts within the BOM; merging the identifiers and the quantity of each of the parts into an array; and hashing the array into the unique identifier. The method includes storing the unique identifier as a primary key for the BOM within a database that includes BOMs of vehicles and assemblies.

In one embodiment, a non-transitory computer-readable medium for organizing a database of vehicle assembly information and including instructions that, when executed by one or more processors, cause the one or more processors to perform one or more functions is disclosed. The instructions include instructions to acquire a bill of materials (BOM) identifying at least parts included within a vehicle build. The instructions include instructions to generate a unique identifier for the BOM by determining identifiers of the parts and a quantity of each of the parts within the BOM, merging the identifiers and the quantity of each of the parts into an array, and hashing the array into the unique identifier. The instructions include instructions to store the unique identifier as a primary key for the BOM within a database that includes BOMs of vehicles and assemblies.

In one embodiment, a system includes one or more processors and a memory storing instructions that, when executed by one or more processors, cause the one or more processors to perform one or more functions is disclosed. The instructions include instructions to acquire a bill of materials (BOM) identifying at least parts included within a vehicle build. The instructions include instructions to generate a unique identifier for the BOM by determining identifiers of the parts and a quantity of each of the parts within the BOM, merging the identifiers and the quantity of each of the parts into an array, and hashing the array into the unique identifier. The instructions include instructions to store the unique identifier as a primary key for the BOM within a database that includes BOMs of vehicles and assemblies.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 illustrates an example vehicle manufacturing environment in which assorted embodiments of a database system can be implemented.

FIG. 2 illustrates portions of the vehicle manufacturing environment of FIG. 1 operated in accordance with some embodiments.

FIG. 3 illustrates portions of an example vehicle assembly system configured to carry out assorted embodiments in the vehicle manufacturing environments of FIGS. 1 and 2.

FIG. 4 illustrates portions of a vehicle assembly system carrying out assorted embodiments.

FIG. 5 illustrates one embodiment of a vehicle assembly system that can be implemented in the vehicle manufacturing environments of FIGS. 1 and 2.

FIG. 6 illustrates portions of an example vehicle assembly system operated in accordance with various embodiments.

FIG. 7 illustrates a flowchart for an example embodiment of a method that can be carried out with the assorted aspects of FIGS. 3-6 in the environments of FIGS. 1 and 2.

### DETAILED DESCRIPTION

Systems, methods, and other embodiments associated with optimizing vehicle assembly through a unique and efficient representation of information are disclosed herein. As previously described, conventional vehicle assembly and manufacturing has organizational difficulties and inefficiencies that can degrade vehicle production performance and consistency. Therefore, the disclosed systems, methods, and other embodiments improve how vehicle assembly is organized. The ability to create a database of vehicle specifications, parts, and packages allows for searching, linking, and intelligent evaluations that can minimize vehicle production volatility and increase production profitability. In particular, efficiently representing information within such a database can be complex where a multiplicity of vehicles, assemblies, and parts are separately represented. Therefore, as described in relation to various embodiments, one or more systems function to use unique identifiers of different vehicle specifications, bills of materials (BOMs), etc. to reduce redundant storage of information.

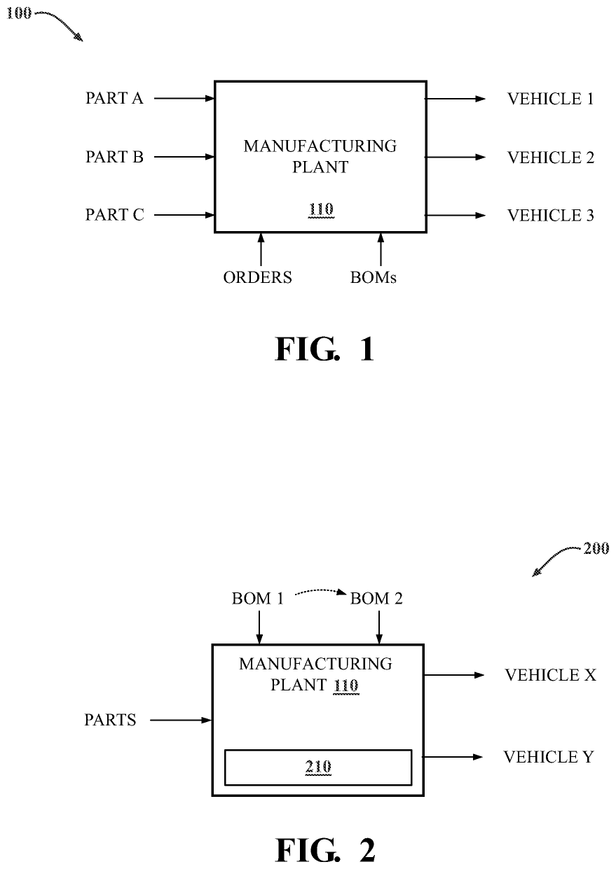

In FIG. 1, a vehicle manufacturing environment 100 is generally illustrated. As used herein, a “vehicle” is any form of transport. In various implementations, a vehicle has two or four wheels that may be powered to move in response to control signals within the vehicle.

The block representation of the vehicle manufacturing environment 100 in FIG. 1 conveys how a manufacturing plant 110 can input a variety of different vehicle parts along with one or more vehicle orders to produce at least one type of vehicle. The inbound flow of different parts can allow the manufacturing plant 110 to create complete vehicles, or portions of vehicles, that have different configurations, as defined by different bill of materials (BOMs). That is, the manufacturing plant 110 can satisfy a variety of different vehicle orders (e.g., different configurations of a vehicle type or different types of vehicles), which can correspond with different BOMs by assembling different parts together. As a result, the manufacturing plant 110 can produce finished vehicles (A/B/C) with different packages and/or part configurations.

However, the vehicle assembly capabilities of the manufacturing plant 110 can be underutilized when parts arrive inconsistently. For instance, receipt of vehicle orders that request different parts, and/or quantities of parts, can create part availability delays and volatility that reduces the ability of the plant 110 to provide optimal vehicle production over time.

FIG. 2 illustrates aspects of a vehicle manufacturing environment 200 in which assorted embodiments translate vehicle orders, and their associated BOMs, into assembled vehicles. It is noted that a BOM may, in some embodiments, result in assembly of less than an entire vehicle or a vehicle that is not yet ready to drive.

While a manufacturing plant 110 is assembling a vehicle based on a single BOM, the flow of vehicle parts is susceptible to volatility in the supply chain. It is contemplated that one or more actions can be taken to increase the reliability and/or consistency of the supply chain for one or more vehicle parts, such as multi-sourcing, on-demand distribution, and warehousing. Such actions to increase supply chain consistency can allow the assorted parts and part quantities constituent in a BOM to be available with less volatility over time.

However, proactive measures to secure a consistent part supply chain may be insufficient to prevent degraded vehicle assembly performance when the manufacturing plant 110 switches between different BOMs (BOM 1 to BOM 2). For instance, alteration of an assigned vehicle specification, BOM, or package for a manufacturing plant, as illustrated by the segmented arrow, can correspond with different parts, part quantities, or part delivery timing that may be difficult to satisfy with an existing supply chain. Hence, various embodiments focus on tracking parts between different BOMs using a database 210 that correlates the parts with different vehicle assemblies, such as different specifications and packages, to allow supply chain and parts storage conditions to be more efficiently understood and proactively adapted to changing demand to create different vehicle builds (Vehicle X or Vehicle Y).

A vehicle assembly database 210 is, in some embodiments, selectively organized to identify current and future supply chain, parts storage, and/or parts delivery conditions. In other words, a database 210 can store parts information that can be intelligently analyzed, viewed, and processed to understand current and future supply chain and manufacturing plant 110 status, which can allow for actions and/or alterations to the fabrication, storage, and delivery of one or more vehicle parts to maintain vehicle assembly performance metrics, such as average production rates, error rates, and average assembly time.

Despite relatively robust vehicle part organization with the database 210, the impact of changes to assigned manufacturing plant specifications, BOMs, and/or packages can be difficult to evaluate. That is, a database 210 can organize vehicle parts by various groupings, such as by source, by plant 210, or by BOM, but such organization can be inefficient in conveying how changes to supply chain, part demand, and/or BOM will impact manufacturing plant performance. Moreover, the database 210 can include redundant data due to the difficulty of identifying related vehicle builds that may have the same BOM but are duplicated within the database 210 because they are separately generated and cannot be easily compared to identify such correspondence. In one example, the database 210 correlates BOMs with constituent parts, but changing which BOM is assigned to a manufacturing plant 110 may involve inefficient and inaccurate calculations associated with determining how changes to different part assortments, part quantities, and/or delivery schedules will result for supply chain consistency, warehousing, and/or vehicle assembly delays.

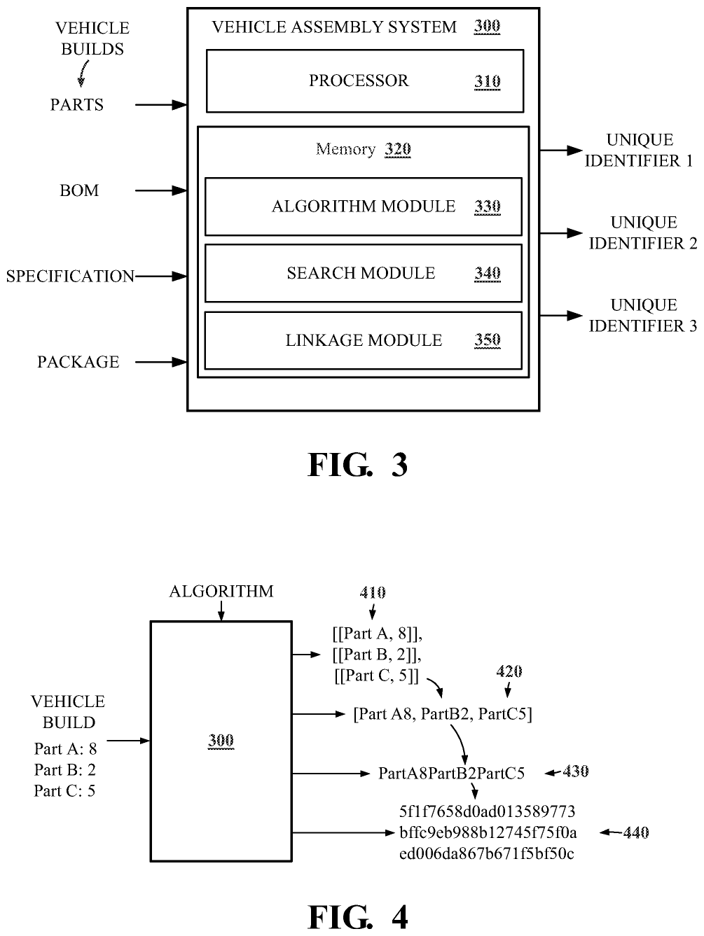

With these difficulties in mind, embodiments of the vehicle assembly environment 200 employ a vehicle assembly system 300 that, for example, generates, organizes, and evaluates relationships between parts using the database 210 to allow efficient and accurate calculation of the impact of one or more changes to various vehicle assembly configurations on supply chain consistency and assembly performance. FIG. 3 illustrates one example of the vehicle assembly system 300 that can be employed in the environments of FIGS. 1 and 2 to provide information to optimally associate parts for vehicle assembly analysis and execution over time.

In various embodiments, the vehicle assembly system 300 utilizes one or more processor(s) 310 that translate various input information into unique identifiers. The processors 310, in one approach, store the unique identifiers in one or more databases in a memory 320 accessed by the processor 310. The processor 310 may be programmable circuitry, such as a microcontroller or application-specific integrated circuit (ASIC), that can employ one or more algorithms to create a unique identifier associated with a vehicle BOM, specification, and/or package.

It is noted that the processor 310 can incorporate the quantity and type of parts constituent in a BOM, or other arrangement (e.g., specification, or package), to create a unique identifier. It should be appreciated that while the present disclosure generally describes generating a unique identifier for a BOM, the system 300 may extend to generating unique identifiers for other combinations of parts that may be, for example, subassemblies or other arrangements. Moreover, while a BOM is described, in further arrangements, the association may instead be with a specification, package, or other arrangement. In any case, it should be appreciated that the system 300 applies the described functions to generate unique identifiers that permit identification of redundant elements and improving efficiency within the database 210. As such, the database 210 can include various identifiers that uniquely correspond with a combination of parts and respective part quantities. For instance, a BOM with three separate parts having respective quantities can be incorporated into a single unique identifier (e.g., Unique Identifier 1), while a different BOM having the same parts with different quantities corresponds with a different unique identifier (e.g., Unique Identifier 2). However, because vehicle specifications tend to be quite complex, direct comparison of BOMs to identify redundancies (i.e., matching BOMs) that originate from different vehicle specifications or packages may not be practical. Therefore, generating the unique identifier in a systematic fashion from the information about the BOM provides a mechanism for identifying and determining when BOMs are the same and therefore reducing redundancies within the database 210. That is, when a BOM matches another BOM associated with different specifications only a single BOM needs to be stored with separate links/references back to the separate specifications.

Through operation of the processor 310, the vehicle assembly system 300 reduces the amount of data, as well as the amount of redundant information, stored in the memory 320. That is, the processor 310 executes instructions of an algorithm module 330 to apply one or more algorithms to generate a unique identifier from information identifying the parts and quantity of parts constituting a BOM. As one example, the algorithm module 330 implements a cryptographic hash algorithm, such as SHA-256, MD5, SHA-512, or Whirlpool functions. The algorithm module 330 uses the hash function to generate the unique identifier as, for example, a single string that identifies a BOM, or, more broadly, a combination of parts and a number of the parts in the combination. Thus, the algorithm module 330 is configured to select an algorithm, or use multiple algorithms in series, that transform identifying information about a vehicle BOM into a single unique identifier with duplicate content removed or reduced by identifying when a newly calculated identifier matches an existing identifier associated with a stored BOM or other combination from which the new BOM or other combination then does not need to be redundantly stored.

It is noted that the algorithm module 330, in at least one approach, provides one or more data encryption and/or compression capabilities that further process a unique identifier into a form that is secure and/or efficiently sized for storage and retrieval. The translation of a BOM into individual unique identifiers allows for intelligent searching and linking via the respective search module 340 and linkage module 350 of the vehicle assembly system 300.

The search module 340, in at least one approach, includes instructions that, when executed by the system processor 310, cause the system processor 310 to execute two-way searching of assorted aspects of parts, BOMs, vehicle specifications, vehicle packages, and other operational metrics involved with arranging parts into a functioning vehicle. It is noted that the unique identifier generated by the vehicle assembly system 300 allows searching for existing identifiers that may match newly generated identifiers to reduce redundancies in the database and may further serve to uniquely identify to which BOMs a part or assembly is linked when used as, for example, foreign keys within a database table for a part/assembly.

Accordingly, the search module 340 provides two-way searching using the unique identifiers to identify what BOMs include an individual part, or collection of parts as well as what parts are included in a selected BOM, specification, or package. Two-way searching, in some embodiments, allows for hierarchical organization of more than one BOM that can be combined to form a vehicle. For instance, the search module 340 may organize parts within the database 210 into a hierarchical tree of different BOMs incorporated into a vehicle, which may allow searching between BOMs.

As a result of the two-way searching from unique identifiers, the search module 340 processes requests to efficiently identify which parts complete a BOM and which BOMs can be satisfied with various parts. The combination of parts and part quantities represented by the unique identifiers further allows the two-way searching to specify the amount of parts to satisfy a BOM as well as which BOMs can be satisfied by a particular number of parts.

In various embodiments, the search module 340 provides operational metrics associated with parts, BOMs, specifications, and/or vehicle packages. Operational metrics can be statistics about a part or BOM. For example, the search module 340 calculates operational statistics, such as time to delivery from a parts source, installation time, cost, profit, size, weight, and color to allow a user to efficiently search and identify the impact of various parts or BOMs on the performance capabilities of a manufacturing plant 110, such as overall time to assemble, procurement delay average, and exposure to supply chain volatility.

In one or more configurations, the linkage module 350 connects different BOMs, specifications, and vehicle packages. For example, by creating a link between different builds for a vehicle, the linkage module 350 provides the ability to discover different BOMs, specifications, and vehicle packages that do not share a searchable feature through the database links. That is, a unique identifier may be assigned one or more links to other BOMs, specifications, packages, manufacturing plants, part sources, or warehouses. The creation of a link between different vehicle builds, part sources, and/or part distribution capabilities allows the vehicle assembly system 300 to efficiently compute an impact of a part, BOM, or other vehicle build has on the manufacturing capabilities and performance of a plant 110. For example, as previously outlined, the system 300 can use the unique identifier as a link to identify a unique BOM and can reduce redundantly stored information via the unique identifier. The unique identifier can function to link a vehicle specification with a BOM instead of storing multiple BOMs that are identical. Thus, when multiple vehicle specifications, assemblies or other grouping identify a common BOM or other higher-level abstraction, the system 300 simply links the specification or other entity with the BOM instead of storing the BOM again. In this way, redundancy within the database is avoided, thereby improving the overall efficiency of the database.

For clarification, the vehicle assembly system 300, in one approach, provides searching and linkage operations via the respective modules 340/350. Two-way searching corresponds with identifying information about specific parts and vehicle builds via the unique identifiers, while linkages within the database 210 provide an explicit mechanism to identify other vehicle builds, part sources, and part distribution information relating to a part or vehicle build. As an example, searching for a BOM can prompt the system 300 to return the constituent parts and part quantities needed to satisfy the BOM, while searching for a part can prompt the system 300 to return part origin information, distribution information, and vehicle builds (BOM/specification) in which the part is included, which are all generally linked via the unique identifier. It should be appreciated that while the present disclosure focuses on vehicle manufacturing, the present techniques can be implemented to realize the same benefits in other contexts as well. For example, wherever a combination of components, such as vehicle parts, is implemented, the system 300 can generate unique identifiers, determine when the combinations are the same, and generate a link between elements to avoid storing redundant information in the database.

To continue the example, a link associated with a unique identifier by the linkage module 350 returns other parts, vehicle builds, or both that are associated with a unique identifier to allow the system 300 to identify which BOMs are influenced by changes to the parts and/or part quantities employed to carry out the unique identifier. The combination of searching the unique identifiers via links in the database 210 affords the vehicle assembly system 300 the ability to quickly and accurately calculate the impact various changes to vehicle assembly will have on future vehicle manufacturing capabilities and/or performance.

FIG. 4 illustrates operation of an example vehicle assembly system 300 conducted in accordance with assorted embodiments to create a unique identifier that can be employed in the vehicle manufacturing environments 100/200 of FIGS. 1 and 2. When a vehicle build is initially generated, the vehicle assembly system 300 compiles the parts (as represented by a part name and/or serial number) and corresponding part quantities into an array in step 410. The vehicle assembly system 300 sorts the compiled information in step 420 to create a single merged array of information associated with a vehicle build, such as a BOM or other combination.

Next, the search module 340 creates a single string from the sorted array by merging array items in step 430. Subsequently, the search module 340 transforms the string from step 430 into a unique identifier in step 440. As noted previously, the search module 340 may apply a hash function, such as a SHA-256 or SHA-512, to generate a unique combination of data bits that enables uniquely representing the combination from which searching can be improved in order to identify redundant combinations and can be assigned links by the vehicle assembly system 300. It is contemplated that step 440 incorporates one or more algorithms associated with data encryption and/or compression that respectively transform a unique identifier into a form that requires an operation, such as decryption or decompression, before being accessible via search or available for impact analysis by the vehicle assembly system 300.

As a result of the creation of a unique identifier, searchability and comparability between different vehicle builds is possible in an efficient and accurate manner since the same combinations of parts result in the same unique identifier, thereby permitting identification of existing BOMs from a generated unique identifier with the same BOM. Additionally, the unique identifiers allow a vehicle assembly system 300 to compute the impact of changes and adaptations to assorted aspects of vehicle manufacturing through generating links within the database from using the unique identifier as, for example, a primary key or other entry within relevant database tables.

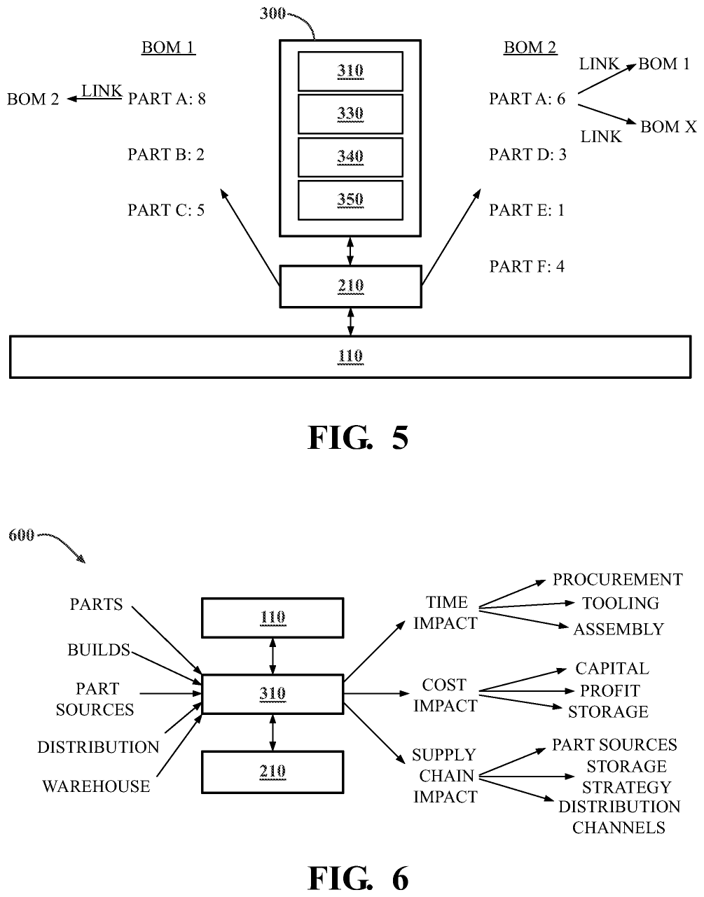

FIG. 5 illustrates aspects of an example vehicle assembly system 300 operated in accordance with assorted embodiments to utilize a unique identifier to optimize a vehicle manufacturing database 210. With a variety of different vehicle builds (BOM) assigned a unique identifier, the vehicle assembly system 300 can provide searching functions. As shown, searching for a particular vehicle part with the vehicle assembly system 300 can return a variety of different information, such as part source, current warehoused volume, time corresponding to distribution from source to manufacturing plant, time to assemble, size, weight, color, and cost.

The intelligent configuration of the database 210 by the vehicle assembly system 300 allows individual parts, as well as collections of parts, to be linked to one or more BOM in which those parts are included. For example, the search module 340 embeds a unique identifier for different BOMs, including a given part with the part in the database 210 as a foreign key while maintaining the unique identifier as a primary key of the BOM. As such, a part can be searched for assorted information and linked to the vehicle builds in which the part is employed while providing an explicit mechanism to identify when a BOM is redundant and, thereby avoid storing redundant information. It is noted that the operations shown in FIG. 5 are performed for a BOM, but such is not limiting as any vehicle build can be processed by the vehicle assembly system 300 into a unique identifier that allows for intelligent searching and linking.

The example database operations of FIG. 5 convey how a BOM can be searched to return the constituent parts and part quantities necessary to satisfy the BOM in a manufacturing plant 110. It is contemplated that the searching of a BOM can include a variety of operational information, such as cost of the collection of parts, time to assemble, distribution times, and current warehoused volumes. The two-way searching capabilities afforded by the unique identifier of a vehicle build allow a user to identify which builds can be manufactured from the collection of parts, as indicated by the dual arrows between the collection of parts and the BOM in FIG. 5. That is, via the unique identifier for a BOM, different parts are linked to the BOM so that the system 300 can identify which parts are associated with different BOMs.

A unique identifier associated with a vehicle build can also have one or more links assigned by a linkage module 350 of the vehicle assembly system 300, such as foreign keys with additional entries in the database 210. That is, for example, when a part is included within a BOM, the unique identifier of the BOM can be included within a database entry for the part as, a foreign key, thereby creating an explicit link between the part and the BOM. As such, a BOM can be logically connected to one or more other BOMs via shared parts, assemblies, etc. that can be influenced by changes to available parts and/or part quantities. For instance, two different BOMs can be linked, either directly via a linkage of foreign keys or indirectly through links of parts to a BOM, due to each having a common constituent part despite having different part quantities, collection of parts, part distribution, part sources, and/or resultant vehicle builds. This linking provides two-way searching from parts to vehicle builds, and vice versa. Additionally, the linking of vehicle builds via shared parts allows a user to efficiently understand the requirements of a variety of different BOMs as well as the capabilities of a vehicle manufacturing plant 110 to change from one vehicle build to another. The proactive evaluation of alterations to one or more aspects of a current, or proposed, vehicle manufacturing plant 110 operations can be characterized as calculating the impact of operational changes.

FIG. 6 illustrates a block representation of portions of an example vehicle assembly environment 600 that employs a vehicle assembly system 300 to calculate the impact of assorted operational changes and generate at least one impact strategy to optimize the performance of a vehicle manufacturing plant 110. It is noted that the calculation of the assorted operational changes in FIG. 6 occurs after the vehicle assembly system 300 generates unique identifiers for each vehicle build being evaluated, which allows for efficient searching and connection between different vehicle builds.

The vehicle assembly system 300 can input information to calculate the impact of a proposed change to one or more operational parameters of the manufacturing plant 110. As shown in FIG. 6, the inputted information allows the vehicle assembly system 300 to calculate the time impact, cost impact, and/or supply chain impact of operational changes. By consulting the database 210, the system 300 can quickly and accurately identify what supply, tooling, and/or operational aspects of the manufacturing plant 110 are to be altered in order to satisfy a proposed change. That is, the vehicle assembly system 300 can determine, from the database 210, what parts, warehouses, part sources, and distribution channels are necessary to complete a proposed vehicle build, which can identify the time, cost, and supply chain deviations from current plant 110 performance and susceptibility to supply chain volatility. This is made possible through the search module 340, providing efficient searches to identify affected parts and BOMs through correlating separate BOMs via the unique identifiers as linked to parts and other related elements in the database 210.

The comparison of current parts, part sources, and distribution channels to the elements that are necessary to satisfy the proposed change to a vehicle build provides the vehicle assembly system 300 sufficient information to determine the operational differences between vehicle builds, such as procurement delays, assembly delays, tooling delays, capital costs, profit margin, storage costs, and supply chain volatility susceptibility. As a non-limiting example, a change between different BOMs, specifications, or package for a vehicle can be evaluated by the vehicle assembly system 300 in view of the inputted information to calculate the time, cost, and/or supply chain ramifications of making the proposed change. As a result of the comparison of different vehicle builds and calculation of the operational differences associated with altering current plant 110 configurations and part procurement, the vehicle assembly system 300 can provide a user with an estimated impact of changing to a different vehicle build.

An impact is not limited to a particular metric, and can be characterized as one or more different factors, such as time, money, exposure, and risk. In response to a proposed change to a vehicle build, the vehicle assembly system 300 compares at least the parts, manufacturing, and supply chain aspects of the current plant configuration to what is necessary to complete the proposed vehicle build. Such analysis by the vehicle assembly system 300 can include the steps, time, and cost associated with changing from the current manufacturing plant configuration as well as the difference in time, cost, and supply chain susceptibility of carrying out the proposed vehicle build compared to the current plant vehicle build. For example, a new BOM can have cost and time impact associated with plant tooling and part procurement along with increased assembly time, personnel cost in assembly, and supply chain susceptibility compared to the current BOM satisfied by the manufacturing plant 110.

The identification of the impact of one or more proposed vehicle builds compared to the current configuration and capabilities of a manufacturing plant 110 allows the vehicle assembly system 300 to provide relatively sophisticated and intelligent options for operators of the manufacturing plant 110. The calculation of the impact to time to change to a new vehicle build for a manufacturing plant 110 can indicate one or more delays, or accelerations, corresponding with altering plant configurations, procuring parts, and/or completing the new vehicle build. Understanding the time impact of multiple different vehicle builds compared to the current operational time performance of the plant 110 allows for intelligent evaluation and selection of a plant activity.

While the vehicle assembly system 300 may calculate a single type of impact for a proposed vehicle build change, some embodiments calculate multiple different types of impact concurrently or sequentially to identify operational and organizational differences that can provide a more thorough understanding of the scope and consequences of a change. As illustrated in FIG. 6, the vehicle assembly system 300 can calculate a cost impact of a proposed vehicle build change that results in an expense, or savings, corresponding with modifying current manufacturing plant 110 operations to capability to satisfy the proposed vehicle build. Such cost impact may be in the form of profit margin, equipment expenditures, part purchasing expenditures, and/or changes to part storage and distribution expenses.

An additional calculation for the vehicle assembly system 300 can provide a supply chain impact that is conveyed as an increase, or decrease, in susceptibility to volatility in the supply chain. That is, the vehicle assembly system 300 can calculate whether the manufacturing plant 110 is more, or less, susceptible to dynamic supply chain factors, such as backorders, recalls, and price fluctuations. As an example, a vehicle build change that requires a part made may a single source can increase risk and susceptibility to supply chain volatility as the part cannot be procured from other sources.

Another example calculates a decreased risk and susceptibility to supply chain volatility in response to a proposed vehicle build change that requires less number of parts, which reduces dependence on distribution channels, warehousing, and delivery. It is noted that the vehicle assembly system 300 can use any number and type of factors to determine a supply chain impact of a proposed vehicle build change, such as the number of part sources, number of parts utilized for a vehicle build, and number of alternative parts. The results of the assorted calculated impacts can be utilized by the vehicle assembly system 300 to generate an impact strategy that provides proactive actions to alter the effects of the change in the vehicle build produced by a manufacturing plant 110.

The generation of an impact strategy can occur automatically, or manually, in response to the vehicle assembly system 300 calculating one or more impacts of a proposed vehicle build change. A strategy can mitigate the negative effects of a vehicle build change by prescribing one or more actions that are directed to reduce time, cost, and/or supply chain volatility susceptibility. A non-limiting example of an impact strategy involves prescribing alteration of a production queue for a vehicle to mitigate delays in tooling, part procurement, part delivery, and/or assembly time.

An impact strategy may also prescribe other actions that mitigate time delays that correspond with changing from one vehicle build to another, such as off-site assembly, alternate part use, or combining multiple aspects of a vehicle build prior to changing tooling or configuration of a manufacturing plant 110. It is noted that the actions prescribed by an impact strategy may not reduce the delays associated with changing from one vehicle build to another, but the proactive actions of an impact strategy can reduce the time impact to end customers, as a whole, by moving when a delay occurs.

An impact strategy, in other embodiments, prescribes actions to mitigate calculated cost impacts. For example, production order for higher profit vehicle builds can be prioritized in a plant's queue or time can be assigned for part reclamation or repair to reduce the cost of a build's parts. Proactive actions can also be prescribed, as part of an impact strategy to mitigate increases to a manufacturing plant's susceptibility to supply chain volatility. Such strategy actions can order greater than usual volumes of parts, move parts closer in a distribution network to a plant 110, or increase part procurement from greater numbers of sources. As a result of the generation and triggering of portions of an impact strategy, time, cost, and supply chain effects can be mitigated to aid in providing peak possible vehicle assembly performance for a manufacturing plant 110 over time despite changing between vehicle builds.

The ability to translate potential vehicle builds into various operational impacts as well as one or more impact strategies allows a vehicle assembly system 300 to provide valuable information about potential operational changes and actions that can be taken to reduce plant performance degradation associated with changing between different vehicle builds. Although the calculated impact of assorted proposed changes to a manufacturing plant 110 can educate a decision maker as to how plant operation and performance will be affected, a choice between multiple different vehicle builds often is not clear, or simple. Accordingly, embodiments of a vehicle assembly system 300 evaluate multiple different potential vehicle builds and takes action automatically, such as suggesting to a decision maker the best available vehicle build based on predetermined rules, criteria, and/or triggering conditions.

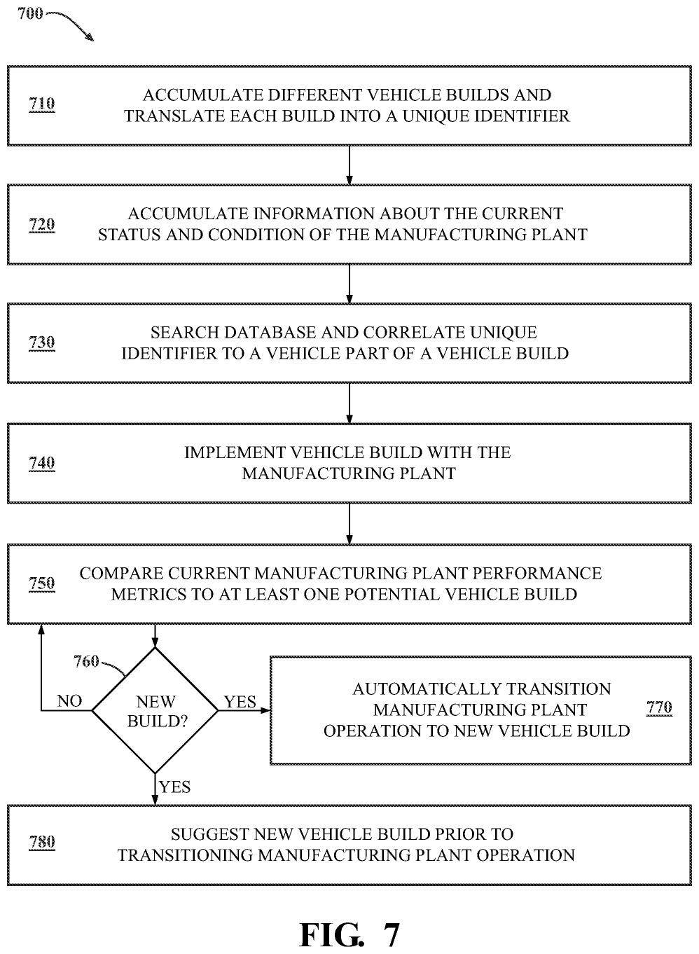

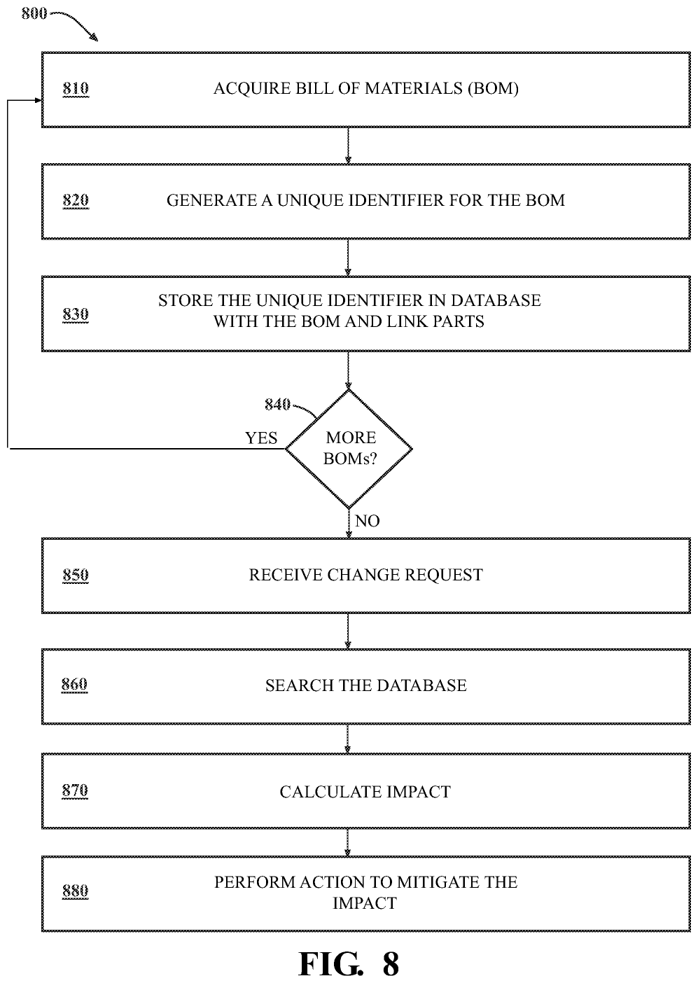

FIG. 7 illustrates a flowchart of a method 700 that is associated with tracking vehicle parts and BOMs using unique identifiers. Method 700 will be discussed from the perspective of the system 300. While method 700 is discussed in combination with the system 300, it should be appreciated that the method 700 is not limited to being implemented within the system 300 but is instead one example of a system that may implement the method 700. A vehicle assembly system can initially translate different vehicle builds into unique identifiers at 710. Each unique identifier correlates the parts and respective part quantities necessary to satisfy individual BOMs, vehicle specifications, and vehicle packages.

While the vehicle assembly system 300 compiles and translates vehicle builds into unique identifiers, at 720, the vehicle assembly system 300 accumulates assorted information about the status and condition of a manufacturing plant. The vehicle assembly system 300 collects the information to permit calculating a diverse variety of performance metrics, such as average assembly time, peak assembly time, profit, capital cost, supply chain susceptibility, and warehouse supply. The combination of unique identifiers formulated for a BOM along with the calculated performance metrics allows the vehicle assembly system 300 to create, update, and otherwise manage a database where unique identifiers are listed, accessible, and linked together based on commonality the primary/foreign key structure. That is, the vehicle assembly system 300 generates and maintains a database of unique identifiers that are linked, as directed by a linkage module of the system 300, to allow efficient correlation of vehicle builds with common parts, part sources, distribution channels, or resulting vehicle assemblies.

With the compilation and maintenance of the database 210, the vehicle assembly system 300 conducts searches, as represented at 730, identifying vehicle builds through searches of parts, constituent parts, or a particular vehicle build. As a result of the searching, the system 300 returns interactive characteristics, such as database representations of vehicles, specifications, packages, BOMs, and/or parts in a hierarchical structure that can be individually, and collectively, selected to link a different vehicle build, as guided by a linkage assigned from the vehicle assembly system 300.

The vehicle assembly system 300 provides, in one arrangement, a vehicle build for use in a manufacturing plant to create portions of a vehicle. At 740, the system 300 implements the vehicle build at the manufacturing plant, where the vehicle build includes one or more BOMs associated with separate unique identifiers from the database 210. Regardless of whether a manufacturing plant is actively producing vehicle assemblies, the vehicle assembly system can be browsed and/or searched with a query, any number of times.

As a result of the review of the database 210, or in response to a proposed change to what vehicle build the manufacturing plant is producing, the vehicle assembly system calculates one or more performance metrics for the proposed vehicle build change, at 750, and compares the calculated metrics to the existing plant status and condition compiled, as described at 720. That is, the vehicle assembly system 300 determines, at 750, changes and differences to satisfy the proposed vehicle build compared to the current vehicle build. For example, at 750, the system 300 utilizes the linkages between unique identifiers in the database to identify at least time, cost, and supply chain alterations to change from the current vehicle build to the proposed vehicle build along with the manufacturing plant performance differences between the current and the proposed vehicle builds during actual fabrication/assembly of the proposed vehicle build.

At 760, the system 300 evaluates a current manufacturing plant status, performance, and capabilities compared to other vehicle builds to suggest a different vehicle build that provides comparative gains in manufacturing plant performance, reliability, and/or consistency. The evaluation of the current vehicle build performance and manufacturing plant status compared to other possible vehicle builds allows the vehicle assembly system 300 to identify opportunities to alter and improve the satisfaction of a vehicle build. Various embodiments of the vehicle assembly system 300 automatically carry out some, or all, of a transition to a different vehicle build at 770 when predetermined triggering conditions are met while other embodiments prompt a user with vehicle build suggestions, at 780, without first conducting the proposed changes.

As an example of the automatic transitioning to a different vehicle build in step 770, the vehicle assembly system can predetermine one or more triggering conditions, such as falling below time, profit, or part availability thresholds, that may be encountered or predicted to occur. Some embodiments of the vehicle assembly system monitor manufacturing plant status and performance and, in response to activity that is non-triggering with respect to the automatic thresholds, identifies opportunities to improve one or more performance metrics, such as time, cost, or supply chain susceptibility, which can be activated at a future time, such as scheduled plant downtime or an equipment repair time window.

It is noted that the resulting vehicle build change, as determined at 760, can involve changing one or more of a queue, a part, or aspects of a supply chain without changing the assembly of parts created by the manufacturing plant. For example, at 760, the system 300 may discover time delays, cost, or supply chain susceptibility can be reduced by increasing part sources, changing distribution channels, or storing more parts on-site at the manufacturing plant while still producing the same vehicle build product. The ability to identify opportunities to increase manufacturing plant performance by consulting the vehicle build database allows a vehicle assembly system to adapt and evolve to changing conditions to provide the best available performance.

The vehicle assembly system 300, in some embodiments, awaits a specific comparison between different vehicle builds to determine consequences of changing the operation of a manufacturing plant. For instance, a customer may request a custom vehicle build or a combination of packages that prompts the vehicle assembly system to calculate the consequences of satisfying the customer's request with current manufacturing plant capabilities. It is contemplated that the vehicle assembly system can identify the computed consequences of a customer's request along with one or more alterations to manufacturing plant operation, as prescribed by an impact strategy, to mitigate plant performance degradation. For instance, a custom vehicle build can result in time delays that are mitigated by changing the build queue of a manufacturing plant, altering on-site part quantities, or converting plant operations to a different BOM.

Some embodiments of the vehicle assembly system 300 respond to changes in manufacturing plant performance and/or supply chain by implementing one or more actions of an impact strategy. Such activation of one or more strategy actions, such as changing build queues, altering part storage quantities, or moving parts on-site from an off-site warehouse, can be conducted for any amount of time in an attempt to provide peak vehicle build performance. However, in response to plant performance remaining degraded despite implementing impact strategy actions, or if no impact actions are predicted to correct manufacturing plant performance/supply chain challenges, the vehicle assembly system can proceed to passively comparing the current vehicle build with other, potential, vehicle builds to find a vehicle build that allows for peak plant performance for current conditions and supply chain status.

By evaluating various vehicle builds with a vehicle assembly system compared to current manufacturing plant performance and capabilities, opportunities can be identified to alter operations and maintain, or reach, peak time, cost, and/or supply chain susceptibility performance. The ability to automatically transition to a different vehicle build in step 770, prompt an opportunity to increase plant performance in step 780, or carry out one or more impact strategy actions without changing the vehicle build allows a vehicle assembly system to intelligently identify opportunities and mitigate negative impact conditions to provide peak manufacturing plant performance, safety, reliability, and consistency over time.

FIG. 8 illustrates a flowchart of a method 800 that is associated with tracking vehicle parts and BOMs using unique identifiers. Method 800 will be discussed from the perspective of the system 300. While method 800 is discussed in combination with the system 300, it should be appreciated that the method 800 is not limited to being implemented within the system 300 but is instead one example of a system that may implement the method 800.

At 810, the system 300 acquires a bill of materials (BOM), or other identifying information, identifying at least parts included within a vehicle build. As specified previously, the BOM is associated with a specification of parts, including identifiers and quantities, for building an assembly or a full vehicle of a particular specification. The BOM may further specify relationships between parts and other aspects relating to the manufacture of the assembly or vehicle.

At 820, the system generates a unique identifier for the BOM. In one approach, to generate the unique identifier, the system 300 undertakes a multi-step process. For example, the system 300 determines identifiers of the parts and a quantity of each of the parts within the BOM. The system 300 then merges the identifiers and the quantities into an array. The method includes hashing the array into the unique identifier. The unique identifier is a single string of data uniquely describing the BOM according to the parts and the quantity of each of the parts within the BOM. Furthermore, it should be noted that hashing the array includes applying a one-way hash function to the array, such that the output is a unique and collision-free identifier of the BOM that can be used within the database to track relationships between parts and different BOMs.

At 830, the system 300 stores the unique identifier as a primary key for the BOM within a database that includes BOMs of vehicles and assemblies. In general, the database (i.e., database 210) is used to track relationships between BOMs and parts along with other information that impacts the manufacturing process. Accordingly, when the system 300 stores the unique identifier, the system 300 may further link the unique identifier to a subsequent identifier that is also unique by integrating a foreign key with an entry of a common part in the database to provide a common reference to BOMs sharing the common part. That is, the system 300 registers the unique identifier as a foreign key with associated aspects in the database 210, such as parts included in the BOM, and so on. Accordingly, in one approach, the unique identifier functions as a primary key of the BOM in the database 210. As a further aspect, the system 300 identifies whether an existing BOM having the same unique identifier already exists within the database 210. If so, then the system 300 does not store the BOM again in order to avoid storing redundant data, but instead, in at least one configuration, links the combination of parts to the existing BOM, thereby reducing the amount of data stored if otherwise stored separately.

At 840, the system 300 determines whether further BOMs are to be stored. When further BOMs are to be stored, the system 300 repeats the functions described at 810-830. Otherwise, the system 300 proceeds to subsequent actions as described at 850-880.

At 850, the system 300 receives a request to change the operation of a manufacturing plant. The request may be to change a vehicle, the characteristics of a vehicle, an assembly, etc. In any case, the request relates to at least one BOM that is being manufactured at a plant and a subsequent BOM, thereby indicating a change at the plant.

At 860, the system 300 searches the database 210 for a bill of materials according to a queried part specified in the request. That is, the system may assess the request to determine parts that may change and then searches the database 210 for the parts, which returns BOMs associated with the particular part. The system 300 may reference foreign keys identified with the part for unique identifiers to determine the BOMs. That is, as previously noted, the unique identifiers that are primary keys of the BOMs are linked to the parts as foreign keys, in one approach. Thus, the system 300 can search the parts and identify the BOMs through these links.

At 870, the system 300 calculates an impact of a change associated with implementing the BOM associated with the unique identifier to a subsequent BOM with the manufacturing plant. For example, the system 300 may determine at least one of: a difference in time, a difference in cost, a difference in supply chain susceptibility to complete the change with the manufacturing plant, a time to transition the manufacturing plant between configurations, and a time to procure parts. From these determinations, the system 300 can derive subsequent information, such as particular impact strategies.

At 880, the system 300 performs an action prescribed by an impact strategy in response to the impact. For example, the action includes, in at least one approach, altering at least one operational parameter of the manufacturing plant while producing the vehicle associated with the BOM. The action generally involves altering a vehicle queue of the manufacturing plant.

Detailed embodiments are disclosed herein. However, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-8, but the embodiments are not limited to the illustrated structure or application.

The flowcharts and block diagrams in the figures illustrate the architecture, functionality, and operation of possible implementations of systems, methods, and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. Any kind of processing system or another apparatus adapted for carrying out the methods described herein is suited. A typical combination of hardware and software can be a processing system with computer-usable program code that, when being loaded and executed, controls the processing system such that it carries out the methods described herein. The systems, components and/or processes also can be embedded in a computer-readable storage, such as a computer program product or other data programs storage device, readable by a machine, tangibly embodying a program of instructions executable by the machine to perform methods and processes described herein. These elements also can be embedded in an application product which comprises all the features enabling the implementation of the methods described herein and, which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: a portable computer diskette, a hard disk drive (HDD), a solid-state drive (SSD), a read-only memory (ROM), an erasable programmable read-only memory (EPROM or Flash memory), a portable compact disc read-only memory (CD-ROM), a digital versatile disc (DVD), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

Generally, modules as used herein include routines, programs, objects, components, data structures, and so on that perform particular tasks or implement particular data types. In further aspects, a memory generally stores the noted modules. The memory associated with a module may be a buffer or cache embedded within a processor, a RAM, a ROM, a flash memory, or another suitable electronic storage medium. In still further aspects, a module as envisioned by the present disclosure is implemented as an application-specific integrated circuit (ASIC), a hardware component of a system on a chip (SoC), as a programmable logic array (PLA), or as another suitable hardware component that is embedded with a defined configuration set (e.g., instructions) for performing the disclosed functions.

Program code embodied on a computer-readable medium may be transmitted using any appropriate medium, including but not limited to wireless, wireline, optical fiber, cable, RF, etc., or any suitable combination of the foregoing. Computer program code for carrying out operations for aspects of the present arrangements may be written in any combination of one or more programming languages, including an object-oriented programming language such as Java™, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . ” as used herein refers to and encompasses any and all possible combinations of one or more of the associated listed items. As an example, the phrase “at least one of A, B, and C” includes A only, B only, C only, or any combination thereof (e.g., AB, AC, BC or ABC).

Aspects herein can be embodied in other forms without departing from the spirit or essential attributes thereof. Accordingly, reference should be made to the following claims, rather than to the foregoing specification, as indicating the scope hereof.

What is claimed is:

1. A method comprising:
acquiring a bill of materials (BOM) identifying at least parts included within a vehicle build;
generating a unique identifier for the BOM by:
determining identifiers of the parts and a quantity of each of the parts within the BOM;
merging the identifiers and the quantity of each of the parts into an array; and
hashing the array into the unique identifier; and
storing the unique identifier as a primary key for the BOM within a database that includes BOMs of vehicles and assemblies.

2. The method of claim 1, wherein storing the unique identifier for the BOM includes identifying whether the unique identifier matches an existing identifier of an existing BOM and linking the vehicle build to the existing BOM instead of storing the BOM, wherein when the unique identifier matches the existing identifier the existing BOM and the BOM are redundant,
wherein the unique identifier is a single string of data uniquely describing the BOM according to the parts and the quantity of each of the parts within the BOM, and wherein hashing the array includes applying a one-way hash function to the array.

3. The method of claim 1, further comprising:
linking the unique identifier to a subsequent identifier that is also unique by integrating a foreign key with an entry of a common part in the database to provide a common reference to BOMs sharing the common part.

4. The method of claim 1, further comprising:
searching, in response to a request, the database for a bill of materials according to a queried part specified in the request, wherein searching the database includes referencing foreign keys identified with a part for unique identifiers.

5. The method of claim 1, further comprising:
calculating an impact of a change associated with implementing the BOM associated with the unique identifier to a subsequent BOM with a manufacturing plant.

6. The method of claim 5, wherein calculating the impact, includes determining at least one of: a difference in time, a difference in cost, a difference in supply chain susceptibility to complete the change with the manufacturing plant, a time to transition the manufacturing plant between configurations, and a time to procure parts.

7. The method of claim 5, further comprising:
performing an action prescribed by an impact strategy in response to the impact, the action including altering at least one operational parameter of the manufacturing plant while producing the vehicle associated with the BOM.

8. The method of claim 7, wherein the action alters a vehicle queue of the manufacturing plant.

9. A non-transitory computer-readable medium including instructions that, when executed by one or more processors, cause the one or more processors to:
acquire a bill of materials (BOM) identifying at least parts included within a vehicle build;
generate a unique identifier for the BOM by:
determining identifiers of the parts and a quantity of each of the parts within the BOM;
merging the identifiers and the quantity of each of the parts into an array; and
hashing the array into the unique identifier; and
store the unique identifier as a primary key for the BOM within a database that includes BOMs of vehicles and assemblies.

10. The non-transitory computer-readable medium of claim 9, wherein the instructions to store the unique identifier for the BOM include instructions to identify whether the unique identifier matches an existing identifier of an existing BOM and link the vehicle build to the existing BOM instead of storing the BOM, wherein when the unique identifier matches the existing identifier the existing BOM and the BOM are redundant, and
wherein the unique identifier is a single string of data uniquely describing the BOM according to the parts and the quantity of each of the parts within the BOM, and wherein the instructions to hash the array include instructions to apply a one-way hash function to the array.

11. The non-transitory computer-readable medium of claim 9, wherein the instructions further include instructions to:
link the unique identifier to a subsequent identifier that is also unique by integrating a foreign key with an entry of a common part in the database to provide a common reference to BOMs sharing the common part.

12. The non-transitory computer-readable medium of claim 9, wherein the instructions further include instructions to:
search, in response to a request, the database for a bill of materials according to a queried part specified in the request, wherein searching the database includes referencing foreign keys identified with a part for unique identifiers.

13. The non-transitory computer-readable medium of claim 9, wherein the instructions further include instructions to:
calculate an impact of a change associated with implementing the BOM associated with the unique identifier to a subsequent BOM with a manufacturing plant.

14. A system, comprising:
one or more processors; and
a memory storing instructions that, when executed by the one or more processors, cause the one or more processors to:
acquire a bill of materials (BOM) identifying at least parts included within a vehicle build;
generate a unique identifier for the BOM by:
determining identifiers of the parts and a quantity of each of the parts within the BOM;
merging the identifiers and the quantity of each of the parts into an array; and
hashing the array into the unique identifier; and
store the unique identifier as a primary key for the BOM within a database that includes BOMs of vehicles and assemblies.

15. The system of claim 14, wherein the instructions to store the unique identifier for the BOM includes identifying whether the unique identifier matches an existing identifier of an existing BOM and linking the vehicle build to the existing BOM instead of storing the BOM, wherein when the unique identifier matches the existing identifier the existing BOM and the BOM are redundant, and
wherein the unique identifier is a single string of data uniquely describing the BOM according to the parts and the quantity of each of the parts within the BOM, and wherein the instructions to hash the array include instructions to apply a one-way hash function to the array.

16. The system of claim 14, wherein the instructions further include instructions to:
link the unique identifier to a subsequent identifier that is also unique by integrating a foreign key with an entry of a common part in the database to provide a common reference to BOMs sharing the common part.

17. The system of claim 14, wherein the instructions further include instructions to:
search, in response to a request, the database for a bill of materials according to a queried part specified in the request, wherein searching the database includes referencing foreign keys identified with a part for unique identifiers.

18. The system of claim 14, wherein the instructions further include instructions to:
calculate an impact of a change associated with implementing the BOM associated with the unique identifier to a subsequent BOM with a manufacturing plant.

19. The system of claim 18, wherein the instructions to calculate the impact, include instructions to determine at least one of: a difference in time, a difference in cost, a difference in supply chain susceptibility to complete the change with the manufacturing plant, a time to transition the manufacturing plant between configurations, and a time to procure parts.

20. The system of claim 18, wherein the instructions further include instructions to:
perform an action prescribed by an impact strategy in response to the impact, the action including altering at least one operational parameter of the manufacturing plant while producing the vehicle associated with the BOM.
